(19) United States
(12) Patent Application Publication
(10) Pub. No.: US 2016/0001371 A1
(43) Pub. Date: Jan. 7, 2016

(54) MAGNETIC COMPONENT, AND SOFT MAGNETIC METAL POWDER USED THEREIN AND MANUFACTURING METHOD THEREOF

(71) Applicant: DOWA Electronics Materials Co., Ltd., Tokyo (JP)

(72) Inventors: Kazumasa IKARI, Okayama (JP); Masahiro GOTOH, Okayama (JP); Takayuki YOSHIDA, Okayama (JP)

(73) Assignee: DOWA ELECTRONICS MATERIALS CO., LTD., Tokyo (JP)

(21) Appl. No.: 14/850,109

(22) Filed: Sep. 10, 2015

Related U.S. Application Data
(62) Division of application No. 14/372,342, filed on Jul. 15, 2014.

(30) Foreign Application Priority Data
Jan. 20, 2012 (JP) 2012-010341

(51) Int. Cl. B22F 9/26; H01F 1/20; B22F 1/02

(52) U.S. Cl. CPC B22F 9/26; B22F 1/02; H01F 1/20; B22F 2201/03; B22F 2301/35; B22F 2302/25; B22F 2303/01

(57) ABSTRACT

A soft magnetic metal powder is manufactured. An aqueous solution of at least one of aluminum, silicon, a rare-earth element (including Y), and magnesium is added into a solution containing an iron ion while blowing a gas containing oxygen thereinto, to form a precursor containing at least one of aluminum, silicon, a rare-earth element (including Y), and magnesium. The precursor is reduced to obtain a metal powder. The metal powder is further slowly oxidized with oxygen to form an oxidized film on the surface of the metal powder.

### CROSS-REFERENCE TO RELATED APPLICATIONS

This is a division of pending U.S. application Ser. No. 14/372,342, filed on Jul. 15, 2014, which is a U.S. National Stage application of International Application No. PCT/JP2013/001638, filed Mach 13, 2013, the content of which are expressly incorporated herein by reference in its entirety.

### FIELD

The present invention relates to a magnetic component used in a high frequency band, and a soft magnetic metal powder constituting the magnetic component and a manufacturing method of the soft magnetic metal powder.

### BACKGROUND

The frequency of signals used in an electronic device such as a cellular phone, a laptop computer and a liquid crystal television device is recently being increased. Signals in the GHz band are already in practical use. It is expected that a frequency band exceeding 10 GHz will be in use in the future. As the frequency of such a device is increased, it is required that individual components such as an electronic circuit and other passive elements also have improved performance in a high frequency range.

In addition, these devices are being decreased in size and power consumption so as to be used as a mobile device. Therefore, the individual components are required to have high performance in a high frequency band, and a lowered loss. However, among the components constituting the device, a passive element has the properties determined on the basis of the physical properties of the used material in many cases. Accordingly, the properties thereof in a high frequency band are not easily improved.

For example, the product properties of magnetic components such as inductors and antennas may be determined by physical properties including dielectric permittivity and magnetic permeability. An inductor is a component that utilizes magnetic flux flowing in the body of the component. In order to obtain an inductor that can be utilized in a high frequency range, a magnetic material that not only maintains the magnetic permeability in a high frequency range but also has a reduced loss even in a high frequency range needs to be developed.

Regarding an antenna, as a communication scheme or technology progresses, an antenna corresponding to a plurality of frequency bands is becoming necessary to be installed. Furthermore, it is desired that the occupied area of an antenna in an electronic device be as small as possible. It is known that the length of an antenna when receiving a certain frequency may be a length inversely proportional to the ½ power of the product of the real part of magnetic permeability and the real part of dielectric permittivity. In brief, in order to obtain a short antenna length, a magnetic material having high magnetic permeability in the frequency range used needs to be developed. Furthermore, since it is most important for an antenna to have a small loss, a magnetic body having a small loss in a high frequency range is needed.

As a magnetic material used in the inductor and the antenna described above, a magnetic iron oxide represented by ferrite, a metal magnetic material which mainly includes iron, and an alloy thereof, (hereafter referred to as a “conventional magnetic material”) is currently used. However, there is a problem in that the magnetic materials cannot be suitably used, because a loss attributable to these magnetic materials increases in a high frequency range of not lower than several hundred MHz. It is considered that this is because the particle diameter larger than the magnetic domain size causes movement of a magnetic domain wall when magnetization is reversed, resulting in generation of a large hysteresis loss. Another possible cause is that the particle diameter equal to or larger than the skin size causes generation of a large eddy current loss.

In such circumstances, nano-order plate-like particles are proposed as metal magnetic particles used in an antenna in Patent Literature 1.

### CITATION LIST

### Patent Literature

Patent Literature 1: Japanese Patent Application Laid-Open No. 2010-103427

### SUMMARY

### Technical Problem

Nano-order magnetic particles are used in a magnetic component used in a high frequency band, so that magnetization is reversed in a unit smaller than that for forming a magnetic domain wall, thereby to reduce a hysteresis loss associated with movement of a magnetic domain wall. Furthermore, the magnetic particles have a size of not larger than a skin depth, so that an eddy current loss is also reduced. In brief, it is considered that the nano-order magnetic particles can be used to obtain a magnetic component having a low loss in a high frequency band.

However, although the magnetic component in which the metal magnetic particles are used, disclosed in Patent Document 1, has a loss smaller than that of the conventional magnetic material, the value of tan δ indicating a loss at 1 GHz is 0.18 according to the description in Paragraph 0104. Therefore, a substance having a further low loss is desired.

Thus, an object of the present invention is to provide a magnetic component having a sufficiently low loss, and a nano-order soft magnetic metal powder used for obtaining the magnetic component and a manufacturing method thereof.

### Solution to Problem

The above-described problem can be solved by forming a magnetic component with a soft magnetic metal powder having a specific structure.

More specifically, the soft magnetic metal powder has the following properties, wherein

iron is a main ingredient,

the average particle diameter thereof is not larger than 300 nm,

the coercive force (Hc) thereof is 16 to 119 kA/m (200 to 1500 Oe),

the saturation magnetization thereof is not less than 90 Am²/kg, and

the volume resistivity thereof is not less than 1.0×10¹ Ω·cm where the volume resistivity is measured by a four probe method in a state of vertically pressurizing 1.0 g of the soft magnetic metal powder at 64 MPa (20 kN).

Furthermore, the above-described soft magnetic metal powder has a core/shell structure, in which the core contains iron or an iron-cobalt alloy while the shell is a composite oxide containing at least one of iron, cobalt, aluminum, silicon, a rare-earth element (including Y), and magnesium.

In the above-described soft magnetic metal powder, the iron-cobalt ratio in the iron-cobalt alloy is Co/Fe=0.0 to 0.6 in terms of atomic ratio.

The above-described soft magnetic metal powder contains aluminum, and the atomic ratio of aluminum to a total sum of Fe and Co is Al/(total of Fe and Co)=0.01 to 0.30.

When the above-described soft magnetic metal powder and an epoxy resin are mixed in a ratio by mass of 80:20 and molded under pressure,

it is satisfied that μ′>1.5 and μ′<0.5, and tan δ<0.15 at a frequency of 1 GHz, as well as μ′>1.5 and μ″<1.5, and tan δ<0.5 at a frequency of 2 GHz, where a real part of complex magnetic permeability thereof is μ′, an imaginary part thereof is μ″, and a loss factor thereof is tan δ(=μ″/μ′).

Furthermore, the present invention provides an inductor and an antenna in which the above-described soft magnetic metal powder is used.

A method of manufacturing a soft magnetic metal powder according to the present invention includes:
a precursor forming step of adding an aqueous solution of at least one of aluminum, silicon, a rare-earth element (including Y), and magnesium into a solution containing an iron ion while blowing a gas containing oxygen thereinto, to form a precursor containing at least one of aluminum, silicon, a rare-earth element (including Y), and magnesium;

a precursor reducing step of reducing the precursor to obtain a metal powder; and

a slow-oxidizing step of further reacting the metal powder obtained in the precursor reducing step with oxygen to form an oxidized film on the surface of the metal powder.

In the above-described manufacturing method, the solution containing an iron ion is an aqueous solution of an iron compound and a cobalt compound.

Furthermore, in the above-described manufacturing method, the precursor obtained in the precursor forming step shows a spinel-type crystal structure by a powder X-ray diffraction method.

Also, in the above-described manufacturing method, the precursor reducing step includes exposing the precursor to a reduction gas at a temperature of 250° C. to 650° C.

Also, in the above-described manufacturing method, the slow-oxidizing step is a step of exposing the metal powder to an inert gas containing oxygen at a temperature of 20° C. to 150° C.

### Advantageous Effects of Invention

According to the soft magnetic metal powder of the present invention, a magnetic component having a low loss, in which the real part μ′ of magnetic permeability at 1 GHz is not less than 1.5 and the loss factor is not more than 0.15, can be obtained.

### BRIEF DESCRIPTION OF DRAWINGS

FIG. 1 is a diagram illustrating a structure of an antenna that is the magnetic component according to the present invention.

FIG. 2 is a diagram illustrating a structure of a coil component that is the magnetic component according to the present invention.

FIG. 3 is a TEM photograph of the soft magnetic powder according to the present invention.

FIG. 4 is a TEM photograph of the soft magnetic powder according to the present invention.

### DESCRIPTION OF EMBODIMENTS

A magnetic component, and a soft magnetic metal powder used in the magnetic component and a manufacturing method thereof according to the present invention will be described below. However, this embodiment is intended to exemplify one embodiment of the present invention, and the contents described below can be modified as long as the gist of the present invention is not deviated.

The magnetic component according to the present invention is composed of a molded body obtained by compression molding the soft magnetic metal powder according to the present invention. As a particular example of the magnetic component, an antenna and a coil component will be exemplified.

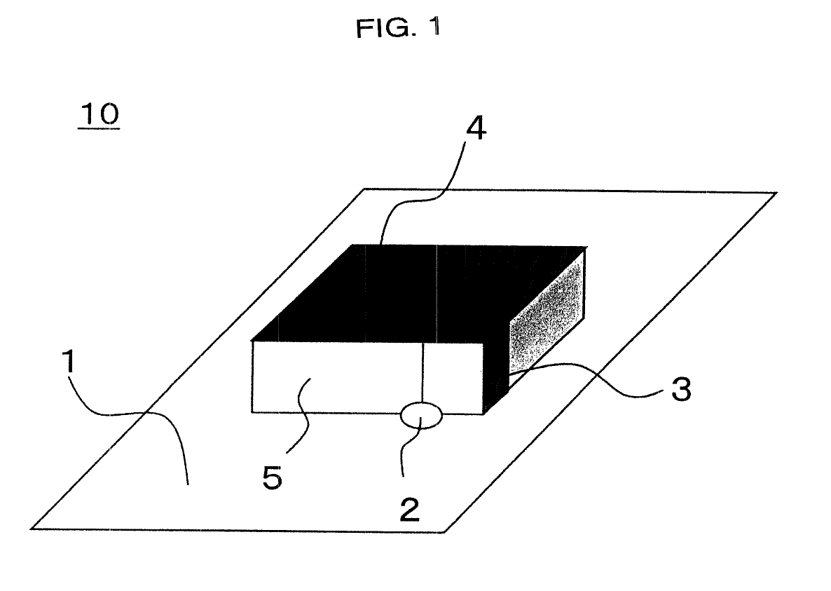

FIG. 1 is a view illustrating one example of an antenna to which a magnetic material for high frequency is applied. An antenna 10 illustrated in the drawing is configured to include a conductor plate 1, a radiation plate 4 disposed on the conductor plate 1, a power supply point 2 and a short circuit plate 3 for supplying power to the radiation plate 4, and a molded body 5. The molded body 5 made of the soft magnetic metal powder is held between the conductor plate 1 and the radiation plate 4. Such a structure enables the wavelength to be shortened, and can realize reduction in size of the antenna 10.

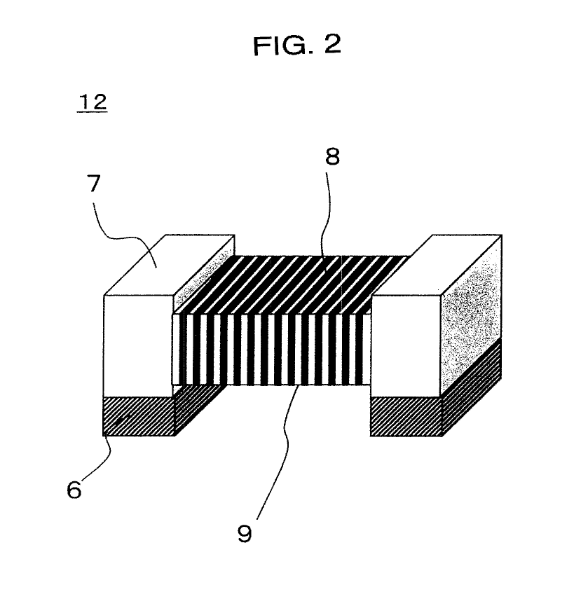

FIG. 2 is a view illustrating one example of a coil component in which a magnetic material for high frequency is used. A coil component 12 illustrated in FIG. 2 is configured to include an electrode 6, a flange 7, a winding wire 8 and a winding core 9. The winding core 9 that is a molded body of the soft magnetic metal powder is shaped as an elongated columnar rectangular parallelepiped, and the cross section in the minor axis direction of the rectangular parallelepiped has a rectangular shape. The flange 7 has a rectangular cross section larger than the rectangular cross section of the winding core 9, and is configured to be a rectangular parallelepiped having a thinner thickness in the major axis direction of the winding core 9. The flange 7 may also be formed with the molded body of the soft magnetic metal powder.

Next, the soft magnetic metal powder according to the present invention will be described in detail.

<Composition of Soft Magnetic Metal Powder>

The soft magnetic metal powder according to the present invention contains Fe (iron), or Fe and Co (cobalt), and at least one of Al (aluminum), Si (silicon), a rare-earth element (including Y (yttrium)) and Mg (magnesium) (hereinafter referred to as “Al and the like”) in Fe, or Fe and Co.

The contained amount of Al and the like to the total sum of Fe and Co is not more than 20 at %. In the state of a precursor before being subjected to a reduction treatment, Al or the like is solid-dissolved in Fe, or Fe and Co. Then, the precursor is reduced to produce a metal powder. In the reduced metal powder, Fe and Co, which are easily reduced, exist inside the particle in a large amount, while aluminum oxide or the like, which is not reduced, exists on the surface of the particle in a large amount.

Thereafter, the surface of the metal powder is oxidized to form an insulating film containing Al and the like. Thus, the electric resistance of the particle constituting the metal powder becomes high. Accordingly, in a magnetic component formed from the metal powder, a loss based on an eddy current loss and the like is improved. Furthermore, when the contained amount of Al is increased, an oxidized film containing a large amount of Al on the surface layer can be formed. Accordingly, the electric resistance of the particle becomes high, and the eddy current loss can be reduced. Thus, tan δ becomes smaller. Here, other than Al or the like, Fe, or Fe and Co can be remained on the surface.

When Co is contained, the contained amount of Co to Fe in terms of atomic ratio (hereinafter referred to as a “Co/Fe atomic ratio”) is 0 to 60 at %. The Co/Fe atomic ratio is more preferably 5 to 55 at %, and further preferably 10 to 50 at %. When the Co/Fe atomic ratio falls within this range, the soft magnetic metal powder is likely to have high saturation magnetization and stable magnetic properties.

Al and the like also have a sintering prevention effect, preventing the particle from becoming large due to sintering during heat processing. As described herein, Al and the like are considered to be one of “sintering prevention elements”. However, Al and the like are non-magnetic components. Therefore, it is not preferable that an excessively large amount of Al and the like be contained, because magnetic properties are diluted. The contained amount of Al and the like to the total sum of Fe and Co is preferably 1 at % to 20 at %, more preferably 3 at % to 18 at %, and further preferably 5 at % to 15 at %.

<Manufacturing Method>

The method of manufacturing a soft magnetic metal powder according to the present invention includes a precursor forming step of forming a precursor, and a precursor reducing step of reducing the obtained precursor into a soft magnetic metal powder. The manufacturing method may further include a slow-oxidizing step of, following to the precursor reducing step, slightly forming an oxidized film on the surface of the soft magnetic metal powder so that handling of the powder becomes easy. The precursor forming step is a wet process, while the precursor reducing step and the slow-oxidizing step are dry processes.

In the precursor forming step, an aqueous solution containing an element(s) as a raw material is oxidized to cause an oxidation reaction, resulting in obtaining particles (a precursor) composed of the element(s) as a raw material.

In the precursor reducing step, the precursor is reduced to remove oxygen contained in the precursor forming step, to obtain a soft magnetic metal powder composed of the element(s) as a raw material. In the slow-oxidizing step, an oxidized film is slightly formed on the surface of the obtained soft magnetic metal powder. The nano-order (soft magnetic) metal powder has high activity and is easily oxidized even at normal temperature. By forming the oxidized film on the surface, the powder can stably exist even in air. Each step will be described in detail below.

<Precursor Forming Step>

In the precursor forming step, a water-soluble iron compound is suitably used as a raw material. As the water-soluble iron compound, iron sulfate, iron nitrate and iron chloride may be preferably used, and iron sulfate may be further preferably used. The reaction is performed by allowing a gas containing oxygen to flow through an aqueous solution of the iron compound, or by adding an aqueous solution of an oxidizing agent such as hydrogen peroxide, so that iron oxide is formed.

The oxidation reaction may be performed in an environment in which divalent iron (Fe²⁺) and trivalent iron (Fe³⁺) coexist. Such coexistence of irons having different valences enables a nucleus to be easily formed, so that particles having an appropriate size can be obtained. Here, an existence ratio between the divalent iron and the trivalent iron is important for controlling the final particle size of the precursor. The existence ratio by mol of Fe²⁺/Fe³⁺ may be 1 to 300, preferably 10 to 150, and further preferably 15 to 100.

Fe²⁺/Fe³⁺ exceeding 300 causes deterioration of particle size distribution, and therefore is not preferred. A larger ratio of Fe²⁺/Fe³⁺ causes a decrease of the number of nuclei and the number of particles. Therefore, the particle size becomes larger. Conversely, a smaller ratio of Fe²⁺/Fe³⁺ causes an increase of the number of nuclei and the number of particles. Therefore, the particle size becomes smaller. Trivalent iron may be provided by adding a trivalent iron compound, or oxidizing divalent iron to produce trivalent iron.

As a raw material, cobalt may be added to iron. As a cobalt material, a water-soluble cobalt compound may be used. This is because the reaction is based on wet system. As the water-soluble cobalt, cobalt sulfate, cobalt nitrate, cobalt chloride and the like may be preferably used, and cobalt sulfate may be further preferably used.

Cobalt may be added preferably before a nucleus is formed, and more preferably together with an iron material. Cobalt can also be added after the end of the oxidation reaction for deposition.

The oxidation for growing a nucleus is preferably performed by blowing air or oxygen into the aqueous solution. This is because the flow rate and the flow velocity can be easily controlled, and a uniform oxidation reaction can be caused in the solution even when a larger manufacturing apparatus is used, by additionally providing an air outlet to the apparatus. Oxidation can also be caused by a method of adding an oxidizing agent.

In addition to iron and cobalt, an element such as aluminum, silicon, a rare-earth element (including Y) and magnesium may be added as a raw material. In order to add these elements, water-soluble compounds thereof may also be preferably used. These elements may be added after iron or iron and cobalt are added in a reaction vessel, during the oxidation reaction so as to be solid dissolved in the precursor, or after the end of the oxidation reaction for deposition. These elements may be added at once or continuously.

<Precursor Reducing Step>

The precursor obtained through the wet process described above is continued to be subjected to the treatment in a dry process.

In the precursor reducing step, the precursor is subjected to a thermal reduction treatment by exposing the precursor to a reducing gas such as carbon monoxide, acetylene or hydrogen at a temperature of 250° C. to 650° C. At this time, a multi-stage reduction may be performed. The multi-stage reduction means that a reduction treatment of retaining a treatment object at a predetermined temperature for a predetermined time is performed a plurality of times while changing the temperature. By properly controlling the temperature and time for retaining the treatment object, the properties of the resultant metal magnetic powder can be controlled. As an atmosphere for the reduction treatment, water vapor may be preferably added in a reducing gas.

<Slow-Oxidizing Step>

An alloy magnetic particle powder is obtained after the thermal reduction. When the alloy magnetic particle powder is handled as it is in the air, it may be rapidly oxidized. Therefore, an oxide layer is formed in the following slow-oxidizing step. In the slow-oxidizing step, the obtained powder is treated while gradually increasing the amount of an oxidizing gas in an inert gas, at a temperature of 20 to 300° C. for a predetermined time, so as to produce an oxide layer on the surface of the particle. Actually, it is preferable that the reduced powder be cooled to a temperature at which the slow-oxidizing step is performed, and slow oxidation be performed at that temperature. Also, the oxide layer may be formed on the surface of the particle with a weak oxidizing gas at this temperature for performing a stabilization treatment. In this process, water vapor may also be added in the weak oxidizing gas for the slow-oxidizing process. By adding water vapor, a more dense film can be formed.

The soft magnetic metal powder which has been subjected to the slow-oxidizing step and obtained as described above was studied on the powder properties and composition by the method shown below.

<Average Particle Diameter>

The average particle diameter was determined as follows: photographing an image of the metal magnetic powder observed in the bright field (for example, at a magnification of 58000) using a transmission electron microscopy (JEM-100CX Mark-II type manufactured by JEOL Ltd.) with an acceleration voltage of 100 kV; enlarging the photographed image (for example, 9 times in vertical and horizontal magnifications), randomly selecting 300 monodispersed particles from a plurality of photographs, measuring the particle diameter for each particle, and calculating an average of the measured particle diameters.

<BET Specific Surface Area>

The BET specific surface area was determined by the BET method using 4 Sorb US manufactured by Yuasa Ionics Inc.

<Evaluation of Magnetic Properties and Weather Resistance of Soft Magnetic Metal Powder>

As magnetic properties (bulk properties) of the obtained soft magnetic metal powder, a coercive force Hc (Oe and kA/m), a saturation magnetization as (Am²/kg) and a squareness ratio SQ were measured using a VSM apparatus (VSM-7P) manufactured by Toei Industry Co., Ltd. with an external magnetic field of 10 kOe (795.8 kA/m). Also, an index (Das) for evaluating weather resistance of the soft magnetic metal powder was determined by retaining the soft magnetic metal powder in a constant temperature and humidity container at a set temperature of 60° C. and a relative humidity of 90% for one week, measuring the saturation magnetizations as before and after retaining the soft magnetic metal powder under the constant temperature and humidity, and calculating (pre-preservation σs− post-preservation σs)/pre-preservation σs×100(%).

<Composition Analysis of Soft Magnetic Metal Powder>

The composition of the soft magnetic metal powder was determined by performing mass analysis of the whole particle containing a metal magnetic phase and an oxidized film. Co, Al, Y, Mg, and Si were quantified using a high frequency induction plasma emission spectrometer ICP (IRIS/AP) manufactured by Nippon Jarrell-Ash Co. Ltd. Fe was quantified using Hiranuma Automatic Titrator (COMTIME-980) manufactured by Hiranuma Sangyo Co., Ltd. Oxygen was quantified using NITROGEN/OXYGEN DETERMETER (TC-436 type) manufactured by LECO Corporation. These quantified results were provided based on mass %. Therefore, the results were appropriately converted to atom % (at %), to calculate a Co/Fe atomic ratio and an Al/(Fe+Co) atomic ratio.

<Measurement of Volume Resistivity of Soft Magnetic Metal Powder>

The volume resistivity of the soft magnetic metal powder was determined by measuring 1.0 g of the powder in a state of being vertically pressurized at 64 MPa (20 kN) by the four probe method, using a powder resistance measuring unit (MCP-PD51) manufactured by Mitsubishi Chemical Analytech Co., Ltd. and a low-resistance powder measuring system software (MCP-PDLGPWIN) manufactured by Mitsubishi Chemical Analytech Co., Ltd.

<Preparation of Molded Body of Soft Magnetic Metal Powder>

The obtained soft magnetic metal powder is kneaded together with a resin into a molded body. As a resin used at this time, any publicly known thermosetting resin can be used. An example of the thermosetting resin can be selected from a phenol resin, an epoxy resin, an unsaturated polyester resin, an isocyanate compound, a melamine resin, a urea resin, a silicone resin and the like. As the epoxy resin, one or a mixture of a mono-epoxy compound and a polyvalent epoxy compound is used.

Here, examples of the mono-epoxy compound may include butyl glycidyl ether, hexyl glycidyl ether, phenyl glycidyl ether, allyl glycidyl ether, para-tert-butylphenyl glycidyl ether, ethylene oxide, propylene oxide, paraxylyl glycidyl ether, glycidyl acetate, glycidyl butyrate, glycidyl hexoate, and glycidyl benzoate.

Examples of the polyvalent epoxy compound may include a bisphenol-type epoxy resin obtained by glycidylating bisphenols such as bisphenol A, bisphenol F, bisphenol AD, bisphenol S, tetramethyl bisphenol A, tetramethyl bisphenol F, tetramethyl bisphenol AD, tetramethyl bisphenol S, tetrabromo bisphenol A, tetrachloro bisphenol A, and tetrafluoro bisphenol A; an epoxy resin obtained by glycidylating other divalent phenols such as biphenol, dihydroxy naphthalene, and 9,9-bis(4-hydroxyphenyl)fluorene; an epoxy resin obtained by glycidylating trisphenols such as 1,1,1-tris(4-hydroxyphenyl)methane and 4,4-(1-(4-(1-(4-hydroxy phenyl)-1-methyl ethyl)phenyl)ethylidene)bisphenol; an epoxy resin obtained by glycidylating tetrakisphenols such as 1,1,2,2,-tetrakis(4-hydroxyphenyl)ethane; a novolak-type epoxy resin and the like obtained by glycidylating novolaks such as phenol novolak, cresol novolak, bisphenol A novolak, brominated phenol novolak, and brominated bisphenol A novolak; an epoxy resin obtained by glycidylating polyvalent phenols, an aliphatic ether-type epoxy resin obtained by glycidylating polyvalent alcohols such as glycerin and polyethylene glycol; an ether ester-type epoxy resin obtained by glycidylating a hydroxycarboxylic acid such as p-oxybenzoic acid and β-oxynaphthoic acid; an ester-type epoxy resin obtained by glycidylating a polycarboxylic acid like a phthalic acid and a terephthalic acid; a glycidyl-type epoxy resin such as an amine-type epoxy resin such as a product obtained by glycidylating an amine compound such as 4,4-diaminodiphenylmethane and m-aminophenol, and triglycidyl isocyanurate, and alicyclic epoxide and the like such as 3,4-epoxycyclohexylmethyl-3′,4′-epoxycyclohexanecarboxylate.

Among the above-described epoxy resins, the polyvalent epoxy resin is preferable from the viewpoint of improving storage stability. Among the polyvalent epoxy resins, a glycidyl-type epoxy resin is preferable since productivity is remarkably high, and the epoxy resin obtained by glycidylating polyvalent phenols is more preferable since a cured product has excellent adhesion and heat resistance. The bisphenol-type epoxy resin is further preferable, and an epoxy resin obtained by glycidylating bisphenol A and an epoxy resin obtained by glycidylating bisphenol F are particularly preferable.

The resin is preferably in a liquid form. The epoxy equivalent is preferably not less than 300 in order to maintain the composition in a solid form.

The mixed ratio of the soft magnetic metal powder and the epoxy resin in terms of metal/resin is preferably 30/70 to 99/1, more preferably 50/50 to 95/5, and further preferably 70/30 to 90/10 at a mass ratio. This is because too little resin does not form a molded body, while too much resin does not provide desired magnetic properties.

The soft magnetic metal powder according to the present invention can be compression molded into a predetermined shape. In a practical use, the molded article to be supplied has a shape exemplified in FIG. 1 and FIG. 2. However, the soft magnetic metal powder was molded into a doughnut shape in the example below, and the molded doughnut-shaped article was evaluated for properties as a magnetic component.

The soft magnetic metal powder and the epoxy resin were weighted at a weight ratio of 80:20, and the soft magnetic metal powder was dispersed in the epoxy resin using a vacuum agitation defoaming mixer (V-mini 300) manufactured by EME Co., Ltd. to prepare a paste. The paste was dried on a hot plate at 60° C. for 2 hours to obtain a soft magnetic metal powder-resin complex. The complex was pulverized to prepare a powder of the complex. Then, 0.2 g of the complex powder was put in a doughnut-shaped container, and subjected to a load of 1 t by a hand press machine. Thus, a toroidal-shaped molded body having an outer diameter of 7 mm and an inner diameter of 3 mm was obtained.

<Evaluation of High-Frequency Properties of Soft Magnetic Metal Powder-Resin Complex>

As high-frequency properties of the molded body of the obtained soft magnetic metal powder-resin complex, a real part (1.0) of magnetic permeability, an imaginary part (0) of magnetic permeability, and tan δ representing a loss factor were measured at 0.5 to 3 GHz, using a network analyzer (E8362C) manufactured by Agilent Technologies Inc. and a coaxial-type S-parameter method sample holder kit (product model No.: CSH2-APC7, sample dimension: 7.0 mm to 3.04 mm in diameter×5 mm) manufactured by Kanto Electronic Application and Development Inc.

### EXAMPLES

### Example 1

The precursor forming step was performed as follows. In a 5000 mL beaker, 3000 mL of pure water and 100 ml of 12 mol/L sodium hydroxide were put, and then stirred while maintaining the temperature at 40° C. with a temperature controller. To the mixture, 900 mL of a solution in which a 2 mol/L ferric sulfate (special grade reagent) solution and a 1 mol/L ferrous sulfate (special grade reagent) aqueous solution were mixed at a mixed ratio of Fe²′/Fe³⁺=20 was added.

Thereafter, the temperature was increased to 90° C., and furthermore, air was flown through at 200 mL/min. Thus, oxidation was continued for 40 minutes. Air was switched to nitrogen, and then aging was conducted for 10 minutes. Thereafter, 80 ml of 0.3 mol/L aluminum sulfate (special grade reagent) was added, and air was flown through at 200 mL/min. Thus, oxidation was continued for 50 minutes to complete the oxidation. In this manner, particles of a precursor in which Al was solid-dissolved in Fe were obtained. The precursor was filtrated and washed with water by an ordinary method, and then dried at 110° C. Thus, a dried solid matter of the precursor (also referred to as a precursor powder) was obtained.

Next, the precursor reducing step was performed. The precursor powder in which Al was solid-dissolved in Fe was put in a basket having a ventilation function, and the basket was placed in a through-type reducing furnace. A reduction treatment was conducted while allowing a hydrogen gas to flow through at 500° C. for 60 minutes. After the reduction treatment was finished, a powder of metal iron (a soft magnetic metal powder) was obtained.

Thereafter, in order to proceed to the slow-oxidizing step, the atmosphere in the furnace was changed from hydrogen to nitrogen, and the temperature in the furnace was reduced to 80° C. at a temperature drop rate of 20° C./min while allowing nitrogen to flow. In the initial stage of oxidized film formation of the slow-oxidizing step, a gas with a mixed ratio of air to N₂ of 1/125 was added in the furnace in order to inhibit the metal iron powder from being rapidly oxidized, to form an oxidized film in the mixed atmosphere of oxygen and nitrogen. Then a supply of air was gradually increased to raise the oxygen concentration in the atmosphere.

The flow rate of added air to be finally supplied was 1/25 relative to N₂. At that time, a total amount of the gas to be introduced in the furnace was maintained constant by adjusting the flow rate of nitrogen. This slow-oxidizing treatment was conducted in the atmosphere of maintaining the temperature at approximately 80° C.

Thus, a final soft magnetic metal powder (having a surface oxidized film) was obtained. The physical properties and bulk properties of the obtained soft magnetic metal powder are shown in Table 2, and the high-frequency properties of the molded body produced with the powder are shown in Table 3. The composition, and the conditions of the precursor reducing step and the slow-oxidizing step are shown in Table 1, including other examples.

### Example 2

In a 5000 mL beaker, 3000 mL of pure water and 100 ml of 12 mol/L sodium hydroxide were put, and then stirred while maintaining the temperature at 40° C. with a temperature controller. To the mixture, 900 mL of a solution in which a 1 mol/L ferrous sulfate (special grade reagent) aqueous solution and a 1 mol/L cobalt sulfate (special grade reagent) solution were mixed at a mixed ratio of 4:1, and a 2 mol/L ferric sulfate (special grade reagent) solution in an amount of satisfying (Fe²⁺+Co²⁺)/Fe³⁺=20 were simultaneously added. After that, the same procedure as in Example 1 was repeated to obtain a soft magnetic metal powder (having a surface oxidized film in which Fe is partly replaced with Co). The physical properties and bulk properties of the obtained soft magnetic metal powder are shown in Table 2, and the high-frequency properties of the molded body produced with the powder are shown in Table 3.

### Example 3

The same procedure as in Example 2 was repeated, except that the mixed ratio between 1 mol/L ferrous sulfate (special grade reagent) aqueous solution and a 1 mol/L cobalt sulfate (special grade reagent) solution in Example 2 was changed to be 8:5. The physical properties and bulk properties of the obtained soft magnetic metal powder are shown in Table 2, and the high-frequency properties of the molded body produced with the powder are shown in Table 3.

Here, Examples 1 to 3 will be discussed. The results show that μ′ was higher in Examples 2 and 3 in which Co was included than in Example 1 in which Co was not included. It is considered that this is because inclusion of Co for providing a FeCo alloy increased the magnetic moment, resulting in higher saturation magnetization, so that the magnetic permeability increased. That is, there is an effect that inclusion of Co increases μ′.

Also, an increase of μ′ usually shifts the resonance frequency to the lower frequency side, so that tan δ tends to deteriorate (become larger). However, in the examples, an increase of a Co amount for raising μ′ did not cause tan δ to deteriorate (become larger). It is considered that this is because inclusion of Co enabled formation of a more dense oxidized film, so that the volume resistivity of the powder increased, resulting in a reduced eddy current loss. That is, it was found that there is an effect that inclusion of Co improves without deteriorating (increasing) tan δ.

### Example 4

The same procedure as in Example 2 was repeated, except that the amount of Fe³⁺ for forming a nucleus was changed to (Fe²⁺+Co²⁺)/Fe³⁺=33, and the amount of 0.3 mol/L aluminum sulfate (special grade reagent) to be added on the way of the oxidation reaction in Example 2 was changed to 45 ml. The physical properties and bulk properties of the obtained soft magnetic metal powder are shown in Table 2, and the high-frequency properties of the molded body produced with the powder are shown in Table 3.

### Examples 5 to 8

In Examples 5 to 8, the same procedure as in Example 4 was repeated, except that the amount of aluminum sulfate in Example 4 was changed to the amount described in Table 1. The physical properties and bulk properties of the obtained soft magnetic metal powder are shown in Table 2, and the high-frequency properties of the molded body produced with the powder are shown in Table 3.

Here, Examples 4 to 8 will be discussed. It was found that there is an effect that an increase of the amount of Al contained reduces tan δ. In the present invention, when the precursor containing Fe, Co and Al is reduced, Fe and Co which are easily reduced exist inside the particle, while aluminum oxide which is not easily reduced exists on the surface of the particle. Accordingly, an oxidized film containing Al on the surface of the particle is formed. For this reason, when the amount of Al is increased, an oxidized film containing more aluminum oxide on the surface of the particle is formed. It is considered that this is the reason why the volume resistivity of the particle was increased, the eddy current loss was decreased, and tan δ was reduced.

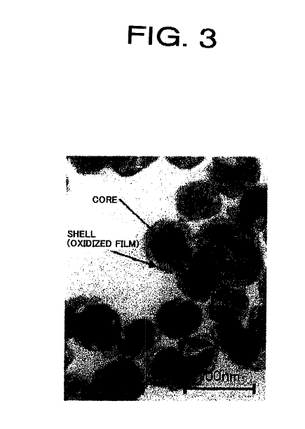

A TEM photograph of the particles obtained in Example 7 is shown in FIG. 3. This TEM image was photographed with an acceleration voltage of 100 kV applied, and the contrast was adjusted so that the core part appears black. As a result, in FIG. 3 shown as an observed example, there is a spherical portion which appears dark in the center of a spherical particle, and a thin portion which appears substantially transparent around the spherical portion. As shown in this photograph, the soft magnetic metal powder obtained in the present invention includes a core portion formed from metal and a shell portion formed from an oxidized film.

The composition of the core/shell particle may be analyzed by a method such as ICP emission analysis, ESCA, TEM-EDX, XPS, and SIMS. Especially, when ESCA is employed, the transition of the composition from the particle surface in the depth direction can be observed. Therefore, the core portion formed from metal and the shell portion formed from an oxide can be recognized. When TEM-EDX is employed, the particle is irradiated with EDX-rays with the beam focused, and is semi-quantified, so that the composition of the particle can be roughly observed. Therefore, the core portion formed from metal and the shell portion formed from an oxide can be recognized (for example, see paragraph [0078] of Japanese Patent Application Laid-Open No. 2006-128535).

### Examples 9 to 10

In Examples 9 to 10, the same procedure as in Example 8 was repeated, except that the reduction temperature in Example 8 was changed to the temperature described in Table 1. The physical properties and bulk properties of the obtained soft magnetic metal powder are shown in Table 2, and the high-frequency properties of the molded body produced with the powder are shown in Table 3.

Here, the reduction temperature differs among Examples 7, 9, and 10. It was found that the example at a higher temperature has a higher μ′ value. It is considered that this is because an increase of the reduction temperature promotes the reduction and the alloying of Fe and Co.

### Example 11

The same procedure as in Example 2 was repeated, except that the reduction temperature by the hydrogen gas in the through-type reducing furnace in Example 2 was changed to 600° C. The physical properties and bulk properties of the obtained soft magnetic metal powder are shown in Table 2, and the high-frequency properties of the molded body produced with the powder are shown in Table 3.

### Example 12

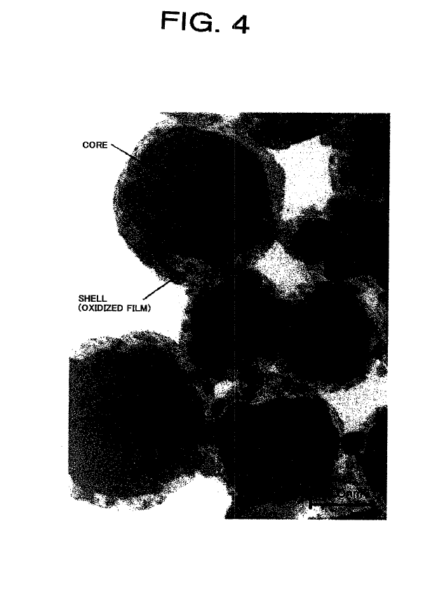

The same procedure as in Example 11 was repeated, except that the amount of Fe³⁺ for forming a nucleus in Example 11 was changed to (Fe²⁺+Co²⁺)/Fe³⁺=85. The physical properties and bulk properties of the obtained soft magnetic metal powder are shown in Table 2, the high-frequency properties of the molded body produced with the powder are shown in Table 3, and a TEM photograph of the obtained powder is shown in FIG. 4. This photograph also shows that the soft magnetic metal powder obtained in the present invention includes the core portion formed from metal and the shell portion formed from an oxidized film.

### Comparative Example 1

As a soft magnetic metal powder of Comparative Example 1, a commercially available Mn—Zn based ferrite powder was used. The physical properties and bulk properties of this soft magnetic metal powder are shown in Table 2, and the high-frequency properties of the molded body produced with the powder are shown in Table 3.

### Comparative Example 2

As a soft magnetic metal powder of Comparative Example 2, a commercially available Fe—Cr—Si powder was used. The physical properties and bulk properties of this soft magnetic metal powder are shown in Table 2, and the high-frequency properties of the molded body produced with the powder are shown in Table 3.

TABLE 1

| | | | | | | | | | | | Stabilizing | | |
|---|---|---|---|---|---|---|---|---|---|---|---|---|---|
| | | | | | | | | | | | (slow-oxidizing) conditions | | |
| | Ferromagnetic metal species | | | | | | | Reduction conditions | | | | Initial | Final |
| | | Cobalt | | Non-magnetic component | | | | Reduc- | | | | oxygen | oxygen |
| | Fe2+/ | | Co/Fe | Additives | | | | tion | Reduc- | | | existence | existence |
| | Fe3+ | | ratio | | Concen- | Added | | temper- | tion | Reduc- | Temper- | ratio | ratio |
| | (Atomic | | (Atomic | | tration | amount | Adding | ature | time | tion | ature | Volume | Volume |
| | ratio) | Type | ratio) | Type | mol/L | ml | method | ° C. | Minutes | species | ° C. | ratio | ratio |
| Example 1 | 20 | None | | Al | 0.3 | 80 | Doping | 500 | 60 | Hydrogen | 80 | 1/125 | 1/25 |
| | | | | | | | | | | gas | | | |
| Example 2 | 20 | Cobalt | 1/4 | Al | 0.3 | 80 | Doping | 500 | 60 | Hydrogen | 80 | 1/125 | 1/25 |
| | | sulfate | | | | | | | | gas | | | |
| Example 3 | 20 | Cobalt | 8/5 | Al | 0.3 | 80 | Doping | 500 | 60 | Hydrogen | 80 | 1/125 | 1/25 |
| | | sulfate | | | | | | | | gas | | | |
| Example 4 | 33 | Cobalt | 1/4 | Al | 0.3 | 45 | Doping | 500 | 60 | Hydrogen | 80 | 1/125 | 1/25 |
| | | sulfate | | | | | | | | gas | | | |
| Example 5 | 33 | Cobalt | 1/4 | Al | 0.3 | 80 | Doping | 500 | 60 | Hydrogen | 80 | 1/125 | 1/25 |
| | | sulfate | | | | | | | | gas | | | |
| Example 6 | 33 | Cobalt | 1/4 | Al | 0.3 | 150 | Doping | 500 | 60 | Hydrogen | 80 | 1/125 | 1/25 |
| | | sulfate | | | | | | | | gas | | | |
| Example 7 | 33 | Cobalt | 1/4 | Al | 0.3 | 220 | Doping | 500 | 60 | Hydrogen | 80 | 1/125 | 1/25 |
| | | sulfate | | | | | | | | gas | | | |
| Example 8 | 33 | Cobalt | 1/4 | Al | 0.3 | 290 | Doping | 500 | 60 | Hydrogen | 80 | 1/125 | 1/25 |
| | | sulfate | | | | | | | | gas | | | |
| Example 9 | 33 | Cobalt | 1/4 | Al | 0.3 | 290 | Doping | 400 | 60 | Hydrogen | 80 | 1/125 | 1/25 |
| | | sulfate | | | | | | | | gas | | | |
| Example 10 | 33 | Cobalt | 1/4 | Al | 0.3 | 290 | Doping | 600 | 60 | Hydrogen | 80 | 1/125 | 1/25 |
| | | sulfate | | | | | | | | gas | | | |
| Example 11 | 20 | Cobalt | 1/4 | Al | 0.3 | 80 | Doping | 600 | 60 | Hydrogen | 80 | 1/125 | 1/25 |
| | | sulfate | | | | | | | | gas | | | |
| Example 12 | 85 | Cobalt | 1/4 | Al | 0.3 | 80 | Doping | 600 | 60 | Hydrogen | 80 | 1/125 | 1/25 |
| | | sulfate | | | | | | | | gas | | | |

TABLE 2

| | Composition | | Particle | | | | | | | | Volume |
|---|---|---|---|---|---|---|---|---|---|---|---|
| | Co/Fe | Al/(Fe + Co) | size | Bulk properties | | | | | | | resistivity |
| | (at %) | (at %) | (nm) | BET | TAP | Hc | σs | SQ | b.SFD | Δσs | Ω · cm |
| Example 1 | 0.00 | 4.15 | 45.3 | 21.7 | 1.17 | 457 | 137 | 0.22 | 3.62 | 8.5 | 1.8E+02 |
| Example 2 | 19.63 | 5.45 | 42.1 | 29.4 | 1.28 | 487 | 179 | 0.24 | 3.88 | 9.1 | 9.1E+03 |
| Example 3 | 49.24 | 5.15 | 44.3 | 31.5 | 1.35 | 533 | 176 | 0.25 | 3.77 | 9.2 | 1.2E+04 |
| Example 4 | 20.43 | 3.64 | 59.1 | 21.5 | 1.26 | 450 | 189 | 0.18 | 4.10 | 7.6 | 5.2E+01 |
| Example 5 | 19.82 | 6.02 | 59.9 | 28.1 | 1.31 | 397 | 183 | 0.15 | 5.13 | 4.9 | 3.5E+04 |
| Example 6 | 20.97 | 10.19 | 58.9 | 38.3 | 1.18 | 427 | 164 | 0.18 | 4.66 | 4.9 | 1.1E+05 |
| Example 7 | 20.48 | 13.01 | 58.2 | 41.0 | 1.10 | 474 | 148 | 0.21 | 4.23 | 4.8 | 1.2E+06 |
| Example 8 | 19.10 | 17.08 | 59.5 | 43.1 | 1.07 | 514 | 132 | 0.25 | 3.59 | 4.9 | 1.8E+06 |
| Example 9 | 20.48 | 13.01 | 68.4 | 34.5 | 1.16 | 718 | 98 | 0.30 | 3.53 | 4.3 | 7.2E+04 |
| Example 10 | 20.48 | 13.01 | 60.5 | 35.8 | 1.16 | 413 | 171 | 0.16 | 5.01 | 4.0 | 1.0E+08 |
| Example 11 | 19.63 | 5.45 | 44.6 | 23.0 | 1.27 | 490 | 182 | 0.24 | 3.85 | 5.8 | 6.3E+03 |
| Example 12 | 20.17 | 5.90 | 212.6 | 27.1 | 1.56 | 288 | 185 | 0.08 | 12.21 | 5.9 | 7.7E+02 |
| Comparative | — | — | 5000.0 | 0.5 | 2.85 | 24 | 85 | 0.02 | 39.56 | 0.4 | 2.5E+02 |
| Example 1 | | | | | | | | | | | |
| Comparative | — | — | 10000.0 | 0.1 | 4.02 | 16 | 167 | 0.01 | 79.88 | 0.9 | 2.9E+02 |
| Example 2 | | | | | | | | | | | |

TABLE 3

| | Ratio of | | | | | | | | | | |
|---|---|---|---|---|---|---|---|---|---|---|---|
| | magnetic | Ratio | | | | | | | | | |
| | powder | of resin | 1.0 GHz | | | 2.0 GHz | | | 3.0 GHz | | |
| | wt % | wt % | μ′ | μ″ | tanδ | μ′ | μ″ | tanδ | μ′ | μ″ | tanδ |
| Example 1 | 80 | 20 | 2.65 | 0.169 | 0.064 | 2.51 | 0.690 | 0.275 | 2.12 | 0.777 | 0.366 |
| Example 2 | 80 | 20 | 3.47 | 0.301 | 0.087 | 3.17 | 1.025 | 0.323 | 2.63 | 1.112 | 0.424 |
| Example 3 | 80 | 20 | 3.33 | 0.213 | 0.064 | 3.27 | 0.795 | 0.243 | 2.83 | 1.002 | 0.354 |
| Example 4 | 80 | 20 | 3.57 | 0.405 | 0.114 | 2.95 | 1.243 | 0.421 | 2.30 | 1.038 | 0.451 |
| Example 5 | 80 | 20 | 3.61 | 0.436 | 0.121 | 2.95 | 1.367 | 0.463 | 2.20 | 1.088 | 0.494 |
| Example 6 | 80 | 20 | 2.99 | 0.228 | 0.076 | 2.77 | 0.979 | 0.354 | 2.10 | 0.943 | 0.449 |
| Example 7 | 80 | 20 | 2.42 | 0.119 | 0.049 | 2.44 | 0.552 | 0.226 | 2.00 | 0.708 | 0.354 |
| Example 8 | 80 | 20 | 2.05 | 0.089 | 0.043 | 2.10 | 0.314 | 0.150 | 1.86 | 0.477 | 0.256 |
| Example 9 | 80 | 20 | 1.60 | 0.024 | 0.015 | 1.61 | 0.038 | 0.024 | 1.64 | 0.069 | 0.042 |
| Example 10 | 80 | 20 | 3.39 | 0.378 | 0.112 | 2.77 | 1.265 | 0.456 | 2.03 | 1.045 | 0.515 |
| Example 11 | 80 | 20 | 3.68 | 0.412 | 0.112 | 3.18 | 1.156 | 0.363 | 2.62 | 1.166 | 0.445 |
| Example 12 | 80 | 20 | 3.09 | 0.336 | 0.109 | 2.89 | 0.526 | 0.182 | 2.81 | 0.619 | 0.221 |
| Comparative | 80 | 20 | 3.56 | 2.122 | 0.596 | 2.24 | 2.087 | 0.933 | 1.56 | 1.779 | 1.139 |
| Example 1 | | | | | | | | | | | |
| Comparative | 80 | 20 | 4.17 | 1.792 | 0.430 | 3.24 | 1.890 | 0.583 | 2.68 | 1.893 | 0.706 |
| Example 2 | | | | | | | | | | | |

### INDUSTRIAL APPLICABILITY

The soft magnetic metal powder according to the present invention can be used not only in inductors and antennas but also in soft magnetic applications such as magnetic heads, lower layer members of magnetic recording media, iron cores of electromagnets, transformer cores, antennas, electromagnetic shield members, and wave absorbers.

### REFERENCE SIGNS LIST

1 Conductor plate
2 Power supply point
3 Short circuit plate
4 Radiation plate
5 Molded body
6 Electrode
7 Flange
8 Winding wire
9 Winding core
10 Antenna
11 Coil
12 Coil component

1. A method of manufacturing a soft magnetic metal powder, comprising:
an aqueous solution of at least one of aluminum, silicon, a rare-earth element (including Y), and magnesium is added into a solution containing an iron ion while blowing a gas containing oxygen thereinto, to form a precursor containing at least one of aluminum, silicon, a rare-earth element (including Y), and magnesium;
the precursor is reduced to obtain a metal powder; and
the metal powder is further slowly oxidized with oxygen to form an oxidized film on the surface of the metal powder.

2. The method of manufacturing a soft magnetic metal powder according to claim 1,
wherein the solution containing an iron ion is an aqueous solution of an iron compound and a cobalt compound.

3. The method of manufacturing a soft magnetic metal powder according to claim 1,
wherein the precursor shows a spinel-type crystal structure by a powder X-ray diffraction method.

4. The method of manufacturing a soft magnetic metal powder according to claim 1,
wherein the reducing the precursor includes exposing the precursor to a reduction gas at a temperature of 250° C. to 650° C.

5. The method of manufacturing a soft magnetic metal powder according to claim 1,
wherein the further reacting comprises exposing the metal powder to an inert gas containing oxygen at a temperature of 20° C. to 150° C.

6. The method of manufacturing a soft magnetic metal powder according to claim 2,
wherein the precursor shows a spinel-type crystal structure by a powder X-ray diffraction method.

7. The method of manufacturing a soft magnetic metal powder according to claim 2,
wherein the reducing the precursor includes exposing the precursor to a reduction gas at a temperature of 250° C. to 650° C.

8. The method of manufacturing a soft magnetic metal powder according to claim 2,
wherein the further reacting comprises exposing the metal powder to an inert gas containing oxygen at a temperature of 20° C. to 150° C.

9. A method of manufacturing a soft magnetic metal powder, comprising:
a precursor forming step of adding an aqueous solution of at least one of aluminum, silicon, a rare-earth element (including Y), and magnesium into a solution containing an iron ion while blowing a gas containing oxygen thereinto, to form a precursor containing at least one of aluminum, silicon, a rare-earth element (including Y), and magnesium;
a precursor reducing step of reducing the precursor to obtain a metal powder; and
a slow-oxidizing step of further reacting the metal powder obtained in the precursor reducing step with oxygen to form an oxidized film on the surface of the metal powder.

10. The method of manufacturing a soft magnetic metal powder according to claim 9, wherein the solution containing an iron ion is an aqueous solution of an iron compound and a cobalt compound.

11. The method of manufacturing a soft magnetic metal powder according to claim 9, wherein the precursor obtained in the precursor forming step shows a spinel-type crystal structure by a powder X-ray diffraction method.

12. The method of manufacturing a soft magnetic metal powder according to claim 9, wherein the precursor reducing step includes exposing the precursor to a reduction gas at a temperature of 250° C. to 650° C.

13. The method of manufacturing a soft magnetic metal powder according to claim 9, wherein the slow-oxidizing step is a step of exposing the metal powder to an inert gas containing oxygen at a temperature of 20° C. to 150° C.

14. The method of manufacturing a soft magnetic metal powder according to claim 10, wherein the precursor obtained in the precursor forming step shows a spinel-type crystal structure by a powder X-ray diffraction method.

15. The method of manufacturing a soft magnetic metal powder according to claim 10, wherein the precursor reducing step includes exposing the precursor to a reduction gas at a temperature of 250° C. to 650° C.

16. The method of manufacturing a soft magnetic metal powder according to claim 10, wherein the slow-oxidizing step is a step of exposing the metal powder to an inert gas containing oxygen at a temperature of 20° C. to 150° C.
